(19) United States
(12) Patent Application Publication
(10) Pub. No.: US 2009/0032395 A1
(43) Pub. Date: Feb. 5, 2009

(54) Biosensor

(76) Inventor: Ching-Hsin Cho, Wugu Hsiang (TW)

Correspondence Address: Andrews & Kurth, L.L. P., Suite 1100, 1350 I street N.W., Washington, DC, 20005, US

(21) Appl. No.: 11/898,509

(22) Filed: Sep. 12, 2007

(30) Foreign Application Priority Data
Jul. 31, 2007 (TW) 096212483

(51) Int. Cl. G01N 27/327

(52) U.S. Cl. 204/403.14; 204/403.01

(57) ABSTRACT

A biosensor is a sensor strip that is folded to form a base and a cover. The base has sides, a reactive layer and two electrodes. The reactive layer is mounted of the base and has a gap. The electrodes are mounted longitudinally on the base respectively near the sides and connect to the reactive layer. The cover bonds to and is shorter than the base and has a sample notch formed in one side of the cover, corresponding to the reactive layer and being near one of the electrodes. Because the sample notch is formed in the side of the cover and blood needs to cross the gap, blood reacts thoroughly with the reactive layer to provide accurate test results.

### BACKGROUND OF THE INVENTION

1. Field of Invention

The present invention relates to a biosensor, and more particularly to a biosensor that allows blood to react thoroughly with a reactive layer, so test results are accurate.

2. Description of the Related Art

Generally, a patient who needs to do periodic blood tests (such as blood sugar measurement, triglyceride measurement, cholesterol measurement, high-density lipoprotein measurement, low-density lipoprotein measurement, etc.) has to go to a hospital to have blood drawn and then go back to the hospital a few days later to obtain the test results. Thus, a lot of time is required for the patient to go to the hospital many times. Moreover, patients cannot obtain an immediate assessment of their physical condition, which can be very dangerous for the patient.

Recently, a biosensor that incorporates a biosensor detector was invented and allows a person to determine his or her physical condition virtually anywhere. The biosensor has a reactive element. The reactive element uses an enzyme to react with a drop of a person's blood and generates an electric current. The biosensor detector in which the biosensor is mounted detects the electric current and displays a test result on a screen of the biosensor detector. Since the biosensor only needs a little blood and takes very little time to provide results, it is convenient for a person to determine his or her physical condition quickly.

With reference to FIG. 4, a conventional biosensor comprises a sensor strip. The sensor strip is folded to form a base (41) and a cover (42). The base (41) has an upper surface, two sides, an end, a distal end, a reactive layer (43) and two electrodes (44, 45). The reactive layer (43) is mounted on the upper surface of the base (41). The electrodes (44, 45) are mounted on the upper surface of the base (41) respectively near the sides of the base (41) and each electrode (44, 45) is formed from the reactive layer (43) to the end of the base (41). The cover (42) is shorter than the base (41), is bonded to the upper surface of the base (41), is flush with the distal end, covers the reactive layer (43) of the base (41) and leaves the end of the base (41) exposed. The cover (42) has a lower surface and a through hole (46). The lower surface has a corresponding reactive layer. The corresponding reactive layer corresponds to the reactive layer (43) of the base (41) and has a center. The through hole (46) is defined through the cover (42) in the center of the corresponding reactive layer and between the electrodes (44, 45).

When the biosensor is used, a drop of blood or other liquid sample is dropped through the through hole (46) onto the reactive layer (43). Blood reacts with the reactive layer (43) to generate electrons. The electrons will move between the electrodes (44, 45) and become a circuit with an electric current. Then, the end of the base (41) is inserted into a biosensor detector to detect the electric current and display a test result.

However, the conventional biosensor has a significant shortcoming. The through hole (46) being formed in the center of the reactive layer (43) and between the electrodes (44, 45) allows blood dropped on the reactive layer (43) to react with the reactive layer (43) to contact the electrodes (44, 45) and allow electrons to move immediately between the electrodes (44, 45) before the blood reacts thoroughly with the reactive layer (43). Therefore, the electric current is unstable, and the test results are not accurate, which can lead to undetected traumatic physical conditions and may lead to death.

To overcome the shortcomings, the present invention provides a biosensor to mitigate or obviate the aforementioned.

### SUMMARY OF THE INVENTION

The primary objective of the present invention is to provide a biosensor that allows blood to react thoroughly with a reactive layer, so test results are accurate.

The biosensor in accordance with the present invention is a sensor strip that is folded to form a base and a cover. The base has an upper surface, two sides, an end, a reactive layer and two electrodes. The reactive layer is mounted on the upper surface of the base and has a gap taht parallels the sides of the base to separate the reactive layer into a first reactive layer and a second reactive layer that is smaller than the first reactive layer. The electrodes are mounted on the upper surface of the base, are mounted respectively near the sides and are mounted respectively from the first reactive layer and second reactive layer to the end of the base. The cover is shorter than the base, is bonded to the upper surface of the base, covers the reactive layer of the base, exposes the end of the base and has two sides, a lower surface and a sample notch. The lower surface has a corresponding reactive layer corresponding to the reactive layer of the base. The sample notch is formed in one side of the cover, corresponds to the first reactive layer of the base and is near one of the electrodes.

Because the sample notch is formed in the side of the cover and blood or another liquid sample needs to cross the gap, the blood or other liquid sample can react thoroughly with the first reactive layer to obtain accurate test results.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a biosensor in accordance with the present invention;

FIG. 2 is a top view of the biosensor in FIG. 1, which is unfolded;

FIG. 3 is a top view of the biosensor in FIG. 1; and

FIG. 4 is a perspective view of a conventional biosensor in accordance with the prior art.

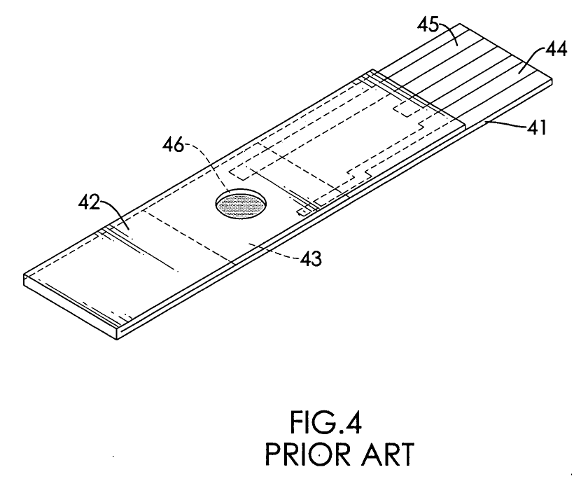

### DETAILED DESCRIPTION OF THE INVENTION

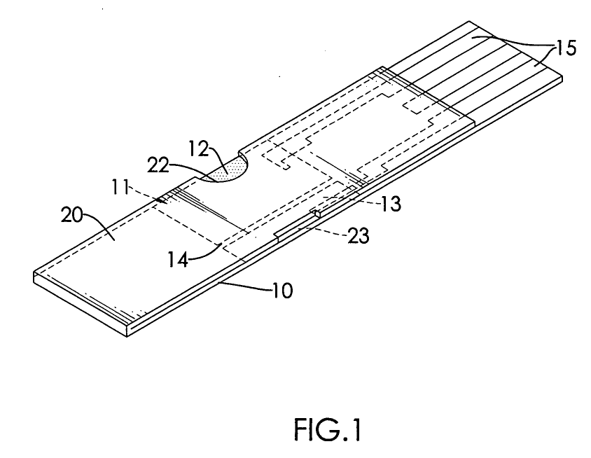

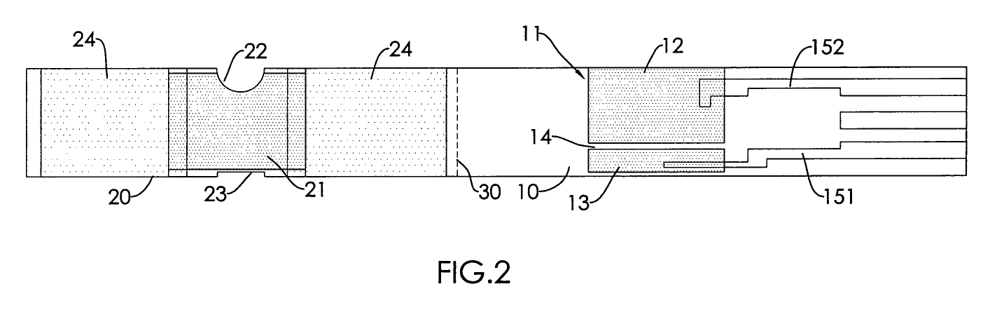

With reference to FIGS. 1 and 2, a biosensor in accordance with the present invention is a sensor strip. The sensor strip is folded along a folding line (30) and comprises a base (10) and a cover (20).

The base (10) has an upper surface, two sides, a end, a reactive layer (11) and two electrodes (15). The end of the base (10) selectively plugs into a biosensor detector.

The reactive layer (11) is mounted on the upper surface of the base (10) and has a gap (14). The gap (14) parallels the sides of the base (10) to separate the reactive layer (11) into a first reactive layer (12) and a second reactive layer (13). The second reactive layer (13) is narrower than the first reactive layer (12). For the biosensor to detect blood sugar, the reactive layer (11) may comprise a composition including: (A) an enzyme (such as glucose oxidase, etc.); (B) enzyme protectors (such as albumin, dextrin, dextran, amino acid, etc.); (C) a conductive medium (such as potassium, etc.); (D) surfactant (such as triton X-100, triton X-405, triton X-114, sodium lauryl sulfate, tween 20 (polyoxyethylenesorbitan monolaurate), tween 40 (polyoxyethylenesorbitan monopalmitate), tween 60 (polyoxyethylenesorbitan monostearate), tween 80 (polyoxyethylenesorbitan monooleate), another water-soluble surfactant, a cleaning agent, etc.); (E) a buffer that is salt (such as phosphate, etc.); and (F) water (such as distilled water).

The electrodes (15) are mounted on the upper surface of the base (10) respectively near the sides of the base (10), extend to the end of the base (10) and overlap and are mounted respectively on the first reactive layer (12) and the second reactive layer (13). Each electrode (15) has an outer end, and the electrodes (15) include an anode (151) and a cathode (152). The anode (151) is a strip, is formed longitudinally on the base (10) adjacent to one side of the base (10) and has an inner end and an outer end. The inner end of the anode (151) is mounted on the second reactive layer (13). The outer end is at the end of the base (10). The cathode (152) is a strip, is shorter than the anode (151) and has an inner end and an outer end. The inner end of the cathode (152) is mounted on the first reactive layer (12). The distal end is at the end of the base (10).

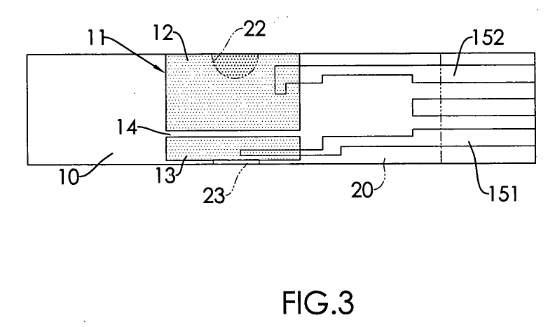

With further reference to FIG. 3, the cover (20) is shorter than the base (10), is bonded to the upper surface of the base (10), covers the reactive layer (11) of the base (10) and exposes the end of the base (10) and the outer ends of the anode (151) and the cathode (152). The cover (20) has two sides, a lower surface, a sample notch (22) and a ventilating notch (23). The lower surface has a corresponding reactive layer (21) and multiple adhesive layers (24). The corresponding reactive layer (21) corresponds to the reactive layer (11) of the base (10) and has two ends. The adhesive layers (24) are mounted on the lower surface of the cover (20), overlap the ends of the corresponding reactive layer (21) and bond to the upper surface of the base (10). The sample notch (22) is formed in one side of the cover (20), corresponds to the first reactive layer (12) of the base (10), is near one of the electrodes (15) specifically the cathode (152) and allows blood or another liquid sample to be dropped on the first reactive layer (12). The ventilating notch (23) is formed in the other side of the cover (20) opposite to the sample notch (22), is near the other electrode specifically the anode (151) and allows the blood or other liquid sample to flow smoothly from the first reactive layer (12) to the second reactive layer (13).

After the blood or another liquid sample is dropped on the first reactive layer (12) through the sample notch (22), the blood or other liquid sample reacts thoroughly with the first reactive layer (12) to generate electrons. The electrons are transferred to the cathode (152) first. Then, the blood or other liquid sample causing the generation of electrons diffuses from the first reactive layer (12), across the gap (14), to the second reactive layer (13). Thus, the blood or other liquid sample reacts thoroughly with the first reactive layer (12), and the electrons transfer to the anode (151). Finally, the anode (151) and the cathode (152) become a circuit with an electric current. Because the blood or other liquid sample reacts thoroughly with the first reactive layer (12), the electric current is stable, and test results are accurate.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A biosensor being a sensor strip that is folded along a folding line and the biosensor comprising
a base having
an upper surface;
two sides;
an end;
a reactive layer being mounted on the upper surface of the base and having a gap that parallels the sides of the base to separate the reactive layer into
a first reactive layer; and
a second reactive layer; and
two electrodes being mounted on the upper surface of the base respectively near the sides of the base, extending to the end of the base and overlapping and being mounted respectively on the first reactive layer and the second reactive layer; and
a cover being shorter than the base, being bonded to the upper surface of the base, covering the reactive layer of the base, exposing the end of the base and the outer ends of the electrodes and having
two sides;
a lower surface having a corresponding reactive layer corresponding to the reactive layer of the base and having two ends; and
a sample notch being formed in one side of the cover, corresponding to the first reactive layer of the base and being near one of the electrodes.

2. The biosensor as claimed in claim 1, wherein the cover further has a ventilating notch being formed in the other side of the cover opposite to the sample notch and being near the other electrode.

3. The biosensor as claimed in claim 2, wherein the second reactive layer of the base is narrower than the first reactive layer of the base.

4. The biosensor as claimed in claim 3, wherein the lower surface of the cover further has adhesive layers being mounted on the lower surface of the cover, overlapping the ends of the corresponding reactive layer and bonding to the upper surface of the base.

5. The biosensor as claimed in claim 4, wherein
the electrodes include
an anode being a strip, being formed longitudinally on the base adjacent to one side of the base and having
an inner end being mounted on the second reactive layer; and
an outer end being at the end of the base; and
a cathode being a strip, being shorter than the anode and having
an inner end mounted on the first reactive layer; and
an outer end being at the end of the base;
the sample notch is near the cathode; and
the ventilating notch is near the anode.

6. The biosensor as claimed in claim 1, wherein the reactive layer comprises a composition including
an enzyme;
enzyme protectors;
surfactant;
a buffer that is salt; and
water.
